(19) United States
(12) Patent Application Publication
(10) Pub. No.: US 2022/0221306 A1
(43) Pub. Date: Jul. 14, 2022

(54) MAP UPDATE SYSTEM

(71) Applicant: HONDA MOTOR CO., LTD., Tokyo (JP)

(72) Inventors: Hidetoshi CHIKAMORI, Saitama (JP); Kazumasa NAKAMURA, Saitama (JP); Hitoshi KONISHI, Saitama (JP); Takuji HARAYAMA, Saitama (JP); Tomoaki MASAKAWA, Tokyo (JP); Naofumi ASO, Saitama (JP); Ryo MATSUZAWA, Tokyo (JP); Zhaoqi WANG, Tokyo (JP)

(21) Appl. No.: 17/573,127

(22) Filed: Jan. 11, 2022

(30) Foreign Application Priority Data
Jan. 12, 2021 (JP) 2021-002839

(51) Int. Cl. G01C 21/00; H04W 4/46

(52) U.S. Cl. CPC G01C 21/3893; H04W 4/46; G01C 21/3841

(57) ABSTRACT

Provided is a system that can reduce the processing load on a map server when map data is delivered and the communication load on a communication path between the map server and a vehicle. In a map update system for updating map data used in a vehicle for travel control, with map data provided from a map server 3, a service vehicle Va, which retains the map data provided from the map server, provides the retained map data to a general vehicle Vb located nearby when the retained map data meets a predetermined provision condition. In particular, the service vehicle provides the retained map data to the general vehicle through vehicle-to-vehicle communications. The map data retained by the service vehicle meets the predetermined provision condition when the map data retained by the service vehicle is newer than map data used in the general vehicle.

### TECHNICAL FIELD

The present invention relates to a map update system for updating map data used in a vehicle for travel control, with map data provided from a server device.

### BACKGROUND ART

Generally, an autonomous driving system controls the traveling of a vehicle by using map data of a high-precision map (HD (High Definition)-MAP) delivered from a map server. Such an autonomous driving system also uses information such as traffic regulation information, road construction information, traffic accident information, and congestion information. These types of information are used as quasi-static information, quasi-dynamic information, and dynamic information, along with map data (high-precision map data) as static information, to form a dynamic map.

The information forming the dynamic map is updated as appropriate, and the latest information records are delivered from the map server to a vehicle, where the vehicle performs an operation for updating information records retained therein with the latest information records.

Known technologies related to updating such map data include a system for monitoring traffic conditions on a real time basis by using multiple communicably connected cars, in which a vehicle having a communication function (i.e., a connected car) can update map data retained therein (see Patent Document 1). In this system, a vehicle used as a connected car also has a V2X (Vehicle-To-Everything) function (that allows for communications between the vehicle and every communication entity).

### PRIOR ART DOCUMENT (S)

### Patent Document(s)

Patent Document 1: JP2019-185756A

### SUMMARY OF THE INVENTION

### Task to be Accomplished by the Invention

High-precision map data includes road surface information, lane information, and detailed information about three-dimensional structures, and thus the data volume of such a map is greater than that of a car navigation map (SD (Standard)-MAP) used in a car navigation system. Accordingly, the use of high-precision map data increases the processing load on a map server in delivering map data to a vehicle, and the communication load on a communication link between the map server and the vehicle. However, the above-described prior art is silent as to reducing the processing load on a map server and the communication load on a communication link; that is, the system of the prior art has a problem of inability to reduce the processing load imposed on a map server and the communication load on a communication link.

The present invention has been made in view of the problem of the prior art, and a primary object of the present invention is to provide a map update system that can reduce the processing load on a map server in delivering map data to a vehicle(s) and the communication load on a communication link between the map server and the vehicle.

### Means to Accomplish the Task

An aspect of the present invention provides a map update system for updating map data used in a vehicle for travel control, with map data provided from a server device, the system comprising: a service vehicle configured to receive and retain the map data provided from the server device so that the service vehicle can provide the retained map data to a general vehicle located nearby, wherein the service vehicle provides the retained map data to the general vehicle when the map data retained by the service vehicle meets a predetermined provision condition, the provision condition being a condition for allowing the map data retained by the service vehicle to be provided to the general vehicle.

This configuration allows the service vehicle in place of the server device to provide the map data to the general vehicle, thereby reducing the processing load imposed on the server device in delivering the map data to the general vehicle.

In the above configuration, the service vehicle may provide the retained map data to the general vehicle through vehicle-to-vehicle communications.

In this configuration, the service vehicle provides map data to the general vehicle by using vehicle-to-vehicle communications, which reduces the communication load on the communication link between the server device and the general vehicle.

In the above configuration, the system may be configured such that, when the map data retained by the service vehicle is newer than map data used in the general vehicle, the retained map data meets the predetermined provision condition, and the service vehicle is allowed to provide the retained map data to the general vehicle.

In this configuration, the general vehicle can retain the latest map data or relatively new map data.

In the above configuration, the system may be configured such that, when the map data retained by the service vehicle is the latest map data, the retained map data meets the predetermined provision condition, and the service vehicle is allowed to provide the retained map data to the general vehicle.

In this configuration, the general vehicle can retain the latest map data.

In the above configuration, the system may be configured such that the server device manages information as to date and time of the last update of the map data retained by the service vehicle, and determines whether or not the retained map data meets the predetermined provision condition.

In this configuration, the server device can play central roles in determining whether or not the map data retained by the service vehicle meets the predetermined provision condition, thereby properly making the determination.

In this case, when the retained map data meets the predetermined provision condition, the server device may instruct the service vehicle to provide the retained map data to the general vehicle, or notify the general vehicle of the service vehicle which is to provide the retained map data so that the general vehicle can requires for the map data to the service vehicle.

In the above configuration, the system may be configured such that one of the service vehicle and the general vehicle acquires information as to date and time of the last update of the map data retained by the other, and determines whether or not the map data retained by the other meets the predetermined provision condition.

In this configuration, one of the service vehicle and the general vehicle can play central roles in determining whether or not the map data retained by the service vehicle meets the predetermined provision condition, thereby properly making the determination.

In the above configuration, the server device may perform an operation for granting an incentive reward to a provider of the service vehicle.

This configuration can grant an incentive reward to a provider of the service vehicle, thereby promoting provision of map data by using the service vehicle in place of the server device.

### Effect of the Invention

The above-described configurations allow a service vehicle in place of a server device to provide map data to a general vehicle, thereby reducing the processing load imposed on the server device in delivering the map data to the general vehicle. In addition, the service vehicle provides map data to the general vehicle by using vehicle-to-vehicle communications, which reduces the communication load on the communication link between the server device and the general vehicle.

### BRIEF DESCRIPTION OF THE DRAWINGS

FIG. 1 is a block diagram showing a schematic configuration of a map update system according to a first embodiment of the present invention;

FIG. 2 is a schematic diagram showing an outline of the map update system according to the first embodiment;

FIG. 3 is a sequence diagram showing an operation procedure of the map update system according to the first embodiment;

FIG. 4 is a sequence diagram showing an operation procedure of a map update system according to a second embodiment of the present invention;

FIG. 5 is a sequence diagram showing an operation procedure of a map update system according to a first variation of the second embodiment;

FIG. 6 is a sequence diagram showing an operation procedure of a map update system according to a second variation of the second embodiment; and

FIG. 7 is a schematic diagram showing an outline of the map update system according to a third embodiment of the present invention.

### DESCRIPTION OF THE PREFERRED EMBODIMENT(S)

Embodiments of the present invention will be described in the following with reference to the appended drawings.

### First Embodiment

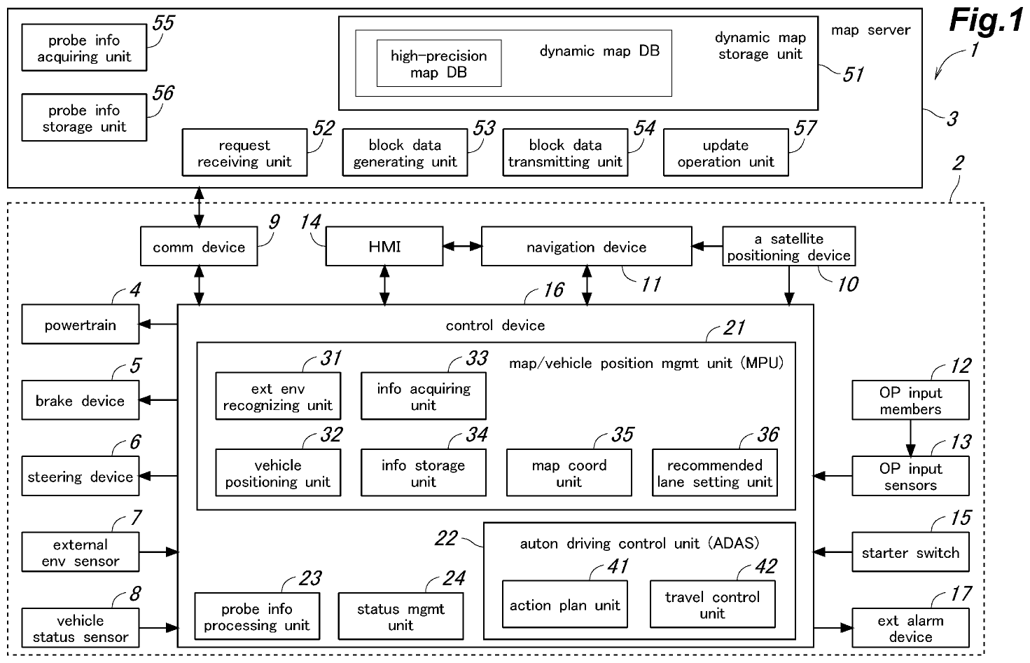

FIG. 1 is a block diagram showing a schematic configuration of a map update system 1 according to a first embodiment of the present invention. The map update system 1 includes a vehicle system 2 mounted in a vehicle and a map server 3 connected to the vehicle system 2 via a network.

The vehicle system 2 includes a powertrain 4, a brake device 5, a steering device 6, an external environment sensor 7, vehicle status sensors 8, a communication device 9, a satellite positioning device 10, a navigation device 11, operation input members 12, and operation input sensors 13, an HMI 14 (human-machine interface), a starter switch 15, a control device 16, and an external alarm device 17. These in-vehicle devices and elements, which constitute part of the vehicle system 2, are connected to each other through a communication network such as CAN (Control Area Network).

The powertrain 4, which provides a driving force to a vehicle, is a power source such that an electric motor or an internal combustion engine. The brake device 5 applies a braking force to a vehicle. The steering device 6 changes the steering angle of the wheels.

The external environment sensor 7 detects an object outside the vehicle by using electromagnetic waves, sound waves, or light reflected from an object located around the vehicle, and may include a radar, a laser radar (lidar), a sonar, and an external camera. The vehicle status sensor 8 detects the status of the vehicle, and may include a vehicle speed sensor and IMUs (Inertial Measurement Unit) for detecting a direction, a gyro, an acceleration, and an inclination state.

The communication device 9 is what is called a TSU (Telematics Service Unit). The communication device 9 communicates with other vehicles, roadside units, and the map server 3. Although communication methods usable by the communication device 9 are not limited to specific communication methods, the communication device 9 may perform communications through WiFi (Registered Trademark) networks, mobile communication networks (mobile phone networks), and/or V2X communications (vehicle-to-vehicle communications, roadside-device-to-vehicle communications).

The satellite positioning device 10 measures the position of the vehicle and outputs the position data (latitude/longitude) of the vehicle by using a satellite positioning system such as Global Navigation Satellite Systems (GNSS).

The navigation device 11 receives data of a destination which an occupant enters by operating the HMI 14, and sets a route (driving path) from the current location of the vehicle to the destination. The navigation device 11 displays the route from the current location of the vehicle to the destination in a screen displayed on the HMI 14, and provides a driver with guidance about the route by using a visual indication displayed on the HMI 14 or voice at an appropriate time.

The operation input members 12 are operated by a driver to drive the vehicle, and may include a steering wheel, an accelerator pedal, a brake pedal, a shift lever, a winker lever, and a power button. The operation input sensors 13 detect operations which a driver performs on the operation input members 12 and may include an accelerator sensor, a steering angle sensor, a brake sensor, and a grip sensor. The starter switch 15 is a switch for activating the vehicle system 2.

The HMI 14 (Human Machine Interface) 5 notifies an occupant(s) of various pieces of information, provides guidance to the occupant, and receives input operations performed by the occupant. The HMI 14 may include a display device (display) for indicating a navigation map on the screen, an input device such as a touch panel, a voice device (speaker) for outputting voice, and an autonomous driving selector switch for switching a driving mode between an autonomous driving mode and a manual operation mode.

The external alarm device 17 provides an alarm to a driver or a pedestrian outside the vehicle, and may include a winker (direction indicator).

The control device 16 includes a map/vehicle position management unit 21, an autonomous driving control unit 22, a probe information processing unit 23, and a status management unit 24. The control device 16 is an electronic control device (ECU) including a storage unit (such as ROM, RAM, HDD, or SSD) and a processor, and each functional unit of the control device 16 is implemented by the processor executing a program(s) stored in the storage unit. Each functional unit of the control device 16 may be composed of a single electronic control device or may be composed of a plurality of electronic control devices.

The map/vehicle position management unit 21 is what is called an MPU (Map Positioning Unit, high-precision vehicle positioning unit). The map/vehicle position management unit 21 includes an external environment recognizing unit 31, a vehicle positioning unit 32, an information acquiring unit 33, an information storage unit 34, a map coordination unit 35, and a recommended lane setting unit 36. The map/vehicle position management unit 21 includes a storage unit (such as ROM, RAM, HDD, or SSD) and a processor, and each functional unit of the map/vehicle position management unit 21 is implemented by the processor and programs stored in the storage unit.

The external environment recognizing unit 31 recognizes obstacles (such as guardrails, utility poles, vehicles, and pedestrians) located around the vehicle, lane markings on the road surface, road side ends based on detection results of the external environment sensor 7.

Based on the position data (latitude and longitude) of the vehicle acquired by the satellite positioning device 10, the vehicle positioning unit 32 identifies the current position of the vehicle in the high-precision map by combining the recognition result of the external environment recognizing unit 31 with the high-precision map in a coordinated fashion. The vehicle positioning unit 32 may identify the current position of the vehicle in the map by utilizing an autonomous navigation method based on a combination of the positioning result acquired by a satellite positioning system such as a GNSS system and the detection result of the IMU as the vehicle status sensor 8.

The information storage unit 34 holds various types of information required for autonomous driving of a vehicle. The information stored in the information storage unit 34 includes information constituting a dynamic map database (dynamic map DB).

Data of the dynamic map includes a combination of information classified into four layers; that is, static information, quasi-static information, quasi-dynamic information, and dynamic information. The static information is high-precision map data, which forms a high-precision map DB, including road surface information, lane information, and information on three-dimensional structures. Quasi-static information includes traffic regulation schedule information, road construction schedule information, wide area weather forecast information, and other related information. Semi-dynamic information includes accident information, road congestion information, traffic regulation information, road construction information, narrow area weather information, and other related information. Dynamic information includes real-time information such as information on vehicles and pedestrians on the road and information on signals.

The update frequencies of static information, quasi-static information, quasi-dynamic information, and dynamic information are different from each other. The dynamic information is updated, for example, once per second. The quasi-dynamic information is updated, for example, once a minute. The quasi-static information is updated, for example, once an hour. Static information is updated, for example, once a month.

The information acquiring unit 33 requests the latest data of a high-precision map to the map server 3 via the communication device 9 (TSU), to thereby acquire the high-precision map data transmitted from the map server 3 in response to the request. Specifically, the information acquiring unit 33 acquires the high-precision map data as a set of block data for predetermined block areas along the route of the vehicle based on the current position of the vehicle acquired by the vehicle positioning unit 32 and the route set by the navigation device 11.

The block data includes static information (high-precision map data) including information about lanes on each road along the route of the vehicle. When the high-precision map data stored in the information storage unit 34 is not the latest map data, the map server 3 delivers differential data between the stored map data and the latest high-precision map data to the control device, and the map/vehicle position management unit 21 performs a map updating operation to update the map data stored in the information storage unit 34 to the latest high-precision map data. The block data also includes quasi-static information such as traffic regulation information related to roads along the route and quasi-dynamic information such as road congestion information related to roads along the route.

The map coordination unit 35 performs a map coordination operation to replace a route in the navigation map (SD (Standard)-MAP) of the vehicle, the route being set by the navigation device 11, with a route in the high-precision map (HD (High Definition)-MAP).
The recommended lane setting unit 36 sets an optimum lane in each road section in the route along with the vehicle is to travel as a recommended lane, based on the route on the high-precision map acquired by the map coordination unit 35, and the quasi-dynamic information and the dynamic information included in the dynamic map data.

The autonomous driving control unit 22 is a control unit used in ADAS (Advanced Driver-Assistance Systems). The autonomous driving control unit 22 includes an action plan unit 41 and a travel control unit 42.

The action plan unit 41 creates an action plan for driving the vehicle along the route for the vehicle set by the navigation device 11. Specifically, the action plan unit 41 determines a sequence of necessary events (i.e., events required to drive the vehicle along the recommended lane without contacting obstacles), and based on those events, generates a target track on which the vehicle is to travel. The target track is a sequence of points at which the vehicle should passes in time series.

The events set by the action plan unit 41 include: a constant speed traveling event which causes the vehicle to travel in the same lane at a constant speed; a lane change event which causes the vehicle to change lanes so that the vehicle travels on the recommended lane; a merging event which causes the vehicle to follow a road merging with another one; a branching event which causes the vehicle to travel towards a desired direction at a branching point on the road; and an intersection event which causes the vehicle to travel at an intersection.

The travel control unit 42 controls the vehicle according to the action plan generated by the action plan unit 41. Specifically, the travel control unit 42 controls the powertrain 4, the brake device 5, and the steering device 6 so that the vehicle follows the target track.

The probe information processing unit 23 collects information on the driving condition of the vehicle at an appropriate time (for example, when a winker is operated or when a brake is operated) and stores the corrected information in a memory. The probe information processing unit 23 transmits information on the driving condition of the vehicle as probe information (travel history information) from the communication device 9 to the map server 3 at an appropriate time.

The probe information includes information records of the position and speed of the vehicle at each time. Moreover, the probe information includes information records identifying the traveling lane at each time. The probe information includes information records of the tilt of the roads acquired from the detection results of the vehicle status sensor 8 or other information. The probe information also includes congestion information acquired from the detection results of the vehicle status sensor 8 or other information. The probe information also includes road update information acquired from the detection results of the operation input sensors 13 and the external environment sensor 7.

The status management unit 24 switches a driving mode of the vehicle between a manual driving mode in which an occupant performs driving operations and an autonomous driving mode in which the vehicle autonomously travels. The driving mode can be switched between the manual driving mode and the autonomous driving mode in response to an occupant's operation. However, in an emergency, the control device switches the driving mode from the autonomous driving mode to the manual driving mode.

The map server 3 (server device) includes a dynamic map storage unit 51, a request receiving unit 52, a block data generating unit 53, a block data transmitting unit 54, and a probe information acquiring unit 55, a probe information storage unit 56, and an update operation unit 57. The map server 3 is a computer provided with a storage unit (such as ROM, RAM, HDD, or SSD) and a processor, and each functional unit of the map server 3 is implemented by the processor and programs in the storage unit. The map server 3 includes a communication unit for communicating with the control device 16 via a network (such as the Internet or mobile communication network). A data center and an edge server may cooperate to implement these functions of the map server 3.

The dynamic map storage unit 51 stores data constituting a dynamic map DB. The dynamic map includes static information (high-precision map information), quasi-static information, quasi-dynamic information, and dynamic information.

The request receiving unit 52 receives a dynamic map transmission request from each vehicle. When the request receiving unit 52 receives a dynamic map transmission request, based on the planned route and the current position of the vehicle, the block data generating unit 53 extracts data, the data corresponding to a predetermined area around the target vehicle and including the planned route of the target vehicle, from the dynamic map storage unit 51 to thereby generate block data. The block data transmitting unit 54 transmits the block data generated by the block data generating unit 53 to the vehicle.

The probe information acquiring unit 55 acquires probe information transmitted from each vehicle as appropriate. The probe information storage unit 56 stores probe information acquired by the probe information acquiring unit 55.

The update operation unit 57 performs statistical processing operations on the probe information stored in the probe information storage unit 56, and updates the dynamic map.

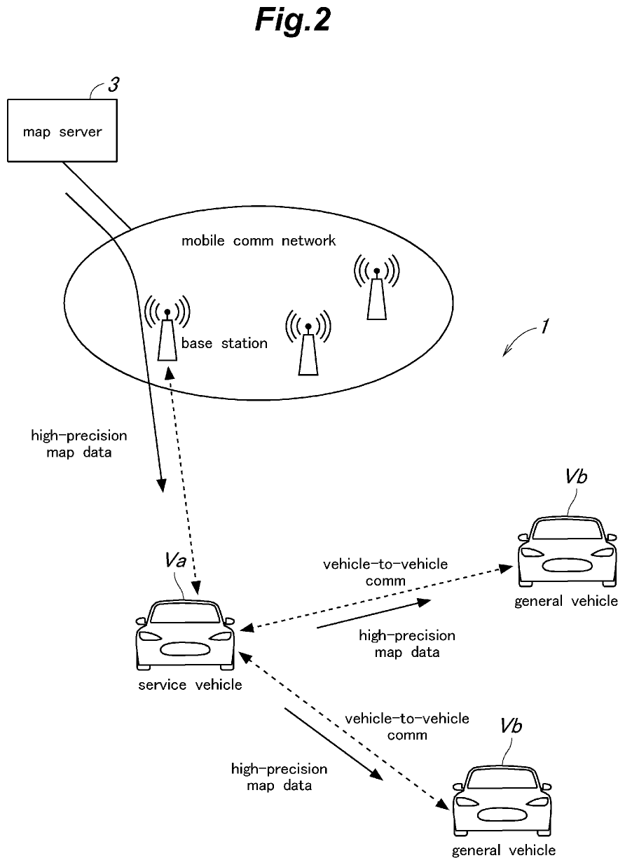

FIG. 2 is a schematic diagram showing an outline of the map update system 1 according to the first embodiment. In the following description, “high-precision map data” is referred to as simply “map data.”

The system includes a service vehicle Va and a general vehicle Vb. The service vehicle Va retains map data provided from the map server 3, and provides the retained map data to the general vehicle Vb located nearby. The general vehicle Vb acquires map data from the service vehicle Va and updates the map data of the vehicle with the acquired map data.

In the present embodiment, map data is provided from the service vehicle Va to the general vehicle Vb through vehicle-to-vehicle communications (V2X communications).

For the vehicle-to-vehicle communications, a relatively high-speed, large-capacity communication method is adopted so that map data with a large data volume can be stably transmitted from the service vehicle to the general vehicle in a short time. In addition, the service vehicle Va acquires map data from the map server 3 using, for example, a mobile communication network.

Controls for autonomous driving or driving assist are performed by using, in addition to map data as static information, quasi-static information and quasi-dynamic information such as traffic regulation information, road construction information, accident information, and traffic congestion information. These types of information other than the map data may be provided from the service vehicle Va to the general vehicle Vb together with the map data. However, since the data volume of these pieces of information other than the map data is small, the map server 3 may directly provide these types of information to the general vehicle Vb without using the service vehicle Va.

In the present embodiment, when the map data retained by the service vehicle Va meets a predetermined provision condition (i.e., a predetermined condition for allowing map data retained by a service vehicle to be provided to a general vehicle), the service vehicle Va provides map data to the general vehicle Vb. In particular, in the present embodiment, the system performs an newer map data determination, i.e., determines whether or not the map data retained by the service vehicle Va is newer than that used in the general vehicle Vb (i.e., determine whether the retained map data meets the predetermined provision condition). When the map data retained by the service vehicle Va is determined to be newer than the general vehicle Vb, the service vehicle Va provides the retained map data to the general vehicle Vb.

In this embodiment, the map server 3 manages block data, i.e., data of each block of the map data retained by the service vehicle Va, and is configured to identify a block area(s) related to a route of a general vehicle Vb which makes a request, and determine whether or not the service vehicle Va retains block data required for the general vehicle Vb (i.e., determine whether the retained map data meets the predetermined provision condition).

The map server also manages information as to date and time of the last update of the map data retained by the service vehicle Va, and is configured to acquire information as to date and time of the last update of the map data retained by the general vehicle Vb, and determine whether or not the map data retained by the service vehicle Va is newer than that used in the general vehicle Vb (i.e., determine whether the retained map data meets the predetermined provision condition). The information as to date and time of the last update of the map data may include version numbers of the map data in addition to the date and time of the last update of map data.

Under this system, a provider (user) of a vehicle needs to make a contract with an operator of the map server 3 for use of map data. With this contract, the provider of the vehicle pays map data usage fees to the operator of the map server 3. In order for the vehicle to receive the map data provided by the map server 3, the vehicle first requests authentication to the map server 3, and upon successful authentication, the vehicle is authorized to receive and use map data provided from the map server.

Moreover, under this system, a provider (user) of a service vehicle Va needs to make a contract with the operator of the map server 3 for using the service vehicle Va to provide map data in place of the map server 3. With this contract, the provider of the service vehicle Va is authorized to supply a service of providing map data. Also, under this contract, the provider of the service vehicle Va is given incentives to supply the map data provision service. Examples of such incentive rewards include a discount on map data usage fees, a coupon, a special benefit, and money (including electronic money).

The map server 3 performs an operation for granting an incentive reward to the provider of a service vehicle Va. Specifically, the map server 3 instructs a system for providing incentive rewards to providers of service vehicles Va (such as a usage fee collection system) to grant an incentive reward to the provider of a certain service vehicles Va.

Generally, providing map data imposes a heavy burden on a service vehicle Va, and involves extra costs. For example, a service vehicle Va is often required to augment hardware to enable transmission of map data with a large data volume, and faces increased power consumption and communication charge caused due to transmission of such a large volume of data. In this view, the system may be configured to offer an incentive reward each time a service vehicle Va provides map data to a general vehicle Vb. In other cases, the type or the amount of an incentive reward granted to the provider of the service vehicle Va may change depending on the number of provision of map data, the data volume of transmitted map data, and/or other factors.

In the present embodiment, the map server 3 performs the operation for granting an incentive reward to providers of the service vehicles Va. However, a server device different from the map server 3 may perform the operation for granting an incentive reward.

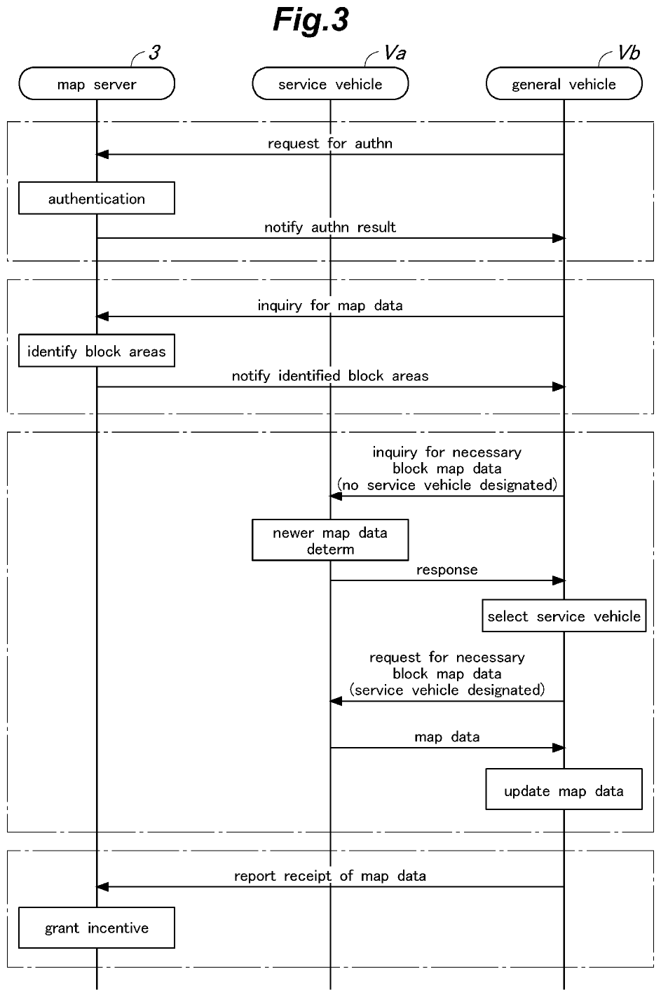

FIG. 3 is a sequence diagram showing an operation procedure of the map update system 1 according to the first embodiment.

In the present embodiment, in order for the system to perform the newer map data determination, determining whether or not the map data retained by a service vehicle Va is newer than that used in a general vehicle Vb (i.e., determine whether the retained map data meets the predetermined provision condition), one of the service vehicle Va and the general vehicle Vb provides information as to date and time of the last update of the map data retained therein to the other through vehicle-to-vehicle communications. In the embodiment shown in FIG. 3, the service vehicle Va plays central roles in determining whether the retained map data meets the predetermined provision condition. Thus, the general vehicle Vb provides information as to date and time of the last update of the map data retained therein to the service vehicle Va and the service vehicle Va performs the newer map data determination.

Specifically, first, a general vehicle Vb accesses the map server 3 and transmits a request for authentication for use of map data. Upon receiving the request for authentication from the general vehicle Vb, the map server 3 verifies the requesting general vehicle Vb (the general vehicle that has requested authentication) and transmits a notification of authentication result to the general vehicle Vb. Upon successful authentication, the general vehicle Vb is authorized to receive and use map data provided from the map server.

Next, at the start of travel control for autonomous driving or driving assist, the general vehicle Vb transmits a data inquiry for map data related to a route of the vehicle to the map server 3. The data inquiry for map data includes information about the current position and the route of own vehicle, and other information.

Next, when receiving the data inquiry for map data from the general vehicle Vb, the map server 3 identifies block areas in the map necessary for the requesting general vehicle Vb based on the information in the data inquiry; that is, information including the current position and the planned route of the general vehicle Vb.

Next, the map server 3 transmits a notification indicating the necessary block areas in the map to the requesting general vehicle Vb.

Next, when receiving the notification indicating the necessary block areas from the map server 3, the requesting general vehicle Vb transmits, based on the information included in the notification, a data inquiry for map data of the necessary brock areas to the surrounding vehicles through vehicle-to-vehicle communications. The data inquiry includes information on the block areas in the map necessary for the requesting general vehicle Vb and information on date and time of the last update of the map data currently retained in the requesting general vehicle Vb. The requesting general vehicle Vb transmits the data inquiry without designating its transmission destination, so that the data inquiry can be received by a service vehicle Va which is located in a communication area for vehicle-to-vehicle communications from the general vehicle Vb.

Then, when receiving the data inquiry for map data from the general vehicle Vb, a service vehicle Va performs the newer map data determination based on the information contained in the data inquiry; that is determines whether or not the service vehicle Va retains newer map data of the necessary block areas than the requesting general vehicle Vb. Then, the service vehicle Va transmits a response to the request, the response including the determination result, to the requesting general vehicle Vb.

Next, when receiving the response from the service vehicle Va, the requesting general vehicle Vb selects the service vehicle Va to request for the map data. When multiple service vehicles Va are located in the communication area for vehicle-to-vehicle communications and the requesting general vehicle Vb transmits a data inquiry for map data without designating its transmission destination through vehicle-to-vehicle communications, the requesting general vehicle Vb receives responses from the multiple service vehicles Va. In such cases, the requesting general vehicle Vb may select the optimum service vehicle Va from those multiple service vehicles Va based on the communication status and other factors.

Next, the requesting general vehicle Vb transmits a request for map data of the designated block areas to the selected service vehicle Va through vehicle-to-vehicle communications.

Then, upon receiving the request for map data from the general vehicle Vb, the service vehicle Va transmits the map data of the necessary block areas to the requesting general vehicle Vb through vehicle-to-vehicle communications.

Next, when receiving the map data from the service vehicle Va, the requesting general vehicle Vb updates the map data retained therein with the received map data.

Next, the requesting general vehicle Vb transmits to the map server 3 a report that the general vehicle Vb has received the map data from the service vehicle Va. Upon receiving that report from the requesting general vehicle Vb, the map server 3 performs an operation for granting an incentive reward to the provider of the service vehicle Va.

In other embodiments, the service vehicle Va may be configured to transmit to the map server 3 a report that the service vehicle Va has transmitted the map data to the requesting general vehicle Vb. In this case, when receiving the report from the service vehicle Va, the map server 3 performs an operation for granting an incentive reward to the provider of the service vehicle Va.

In the present embodiment, the service vehicle Va plays central roles in determining whether the retained map data meets the predetermined provision condition; that is, the service vehicle Va is configured to acquire information as to date and time of the last update of the map data retained by the general vehicle Vb, and performs the newer map data determination, i.e., determines whether or not the map data retained by the service vehicle Va is newer than that used in the general vehicle Vb. However, the general vehicle Vb may play central roles in determining whether the retained map data meets the predetermined provision condition. In this case, the general vehicle Vb acquires information as to date and time of the last update of the map data retained by the service vehicle Va from the service vehicle Va.

In the present embodiment, when a service vehicle Va retains newer map data than a general vehicle Vb, the map data retained by the service vehicle Va is provided to the general vehicle Vb. Thus, although the map data the general vehicle Vb receives from the service vehicle Va is not always the latest data, the general vehicle Vb can acquire relatively new map data.

If the service vehicle Va frequently inquires of the map server 3 about the update status of the map data and retains the new map data as much as possible, the general vehicle Vb can acquire the latest map data from the service vehicle Va . . . .

When the requesting general vehicle Vb transmits a request for map data to surrounding vehicles through vehicle-to-vehicle communications and a service vehicle Va is located nearby as a surrounding vehicle, the service vehicle Va can respond to the request for map data from the requesting general vehicle Vb. However, in some cases, there is no service vehicle Va located nearby, or in other cases, service vehicles Va are unable to properly respond to the request due to a poor communication environment or for other reasons. In such cases, the requesting general vehicle Vb may give up acquiring map data from a service vehicle Va and receive the map data from the map server 3, instead.

In the present embodiment, map data is transmitted between a service vehicle Va and a general vehicle Vb through vehicle-to-vehicle communications. In addition, the map server 3 performs communications with general vehicles Vb and service vehicles Va to transmit a request for map data, a notification of block areas in the map necessary for a general vehicle Vb, and other data. However, since the data volume of control data is small, such communications do not significantly increase the processing load on the map server 3 and the communication load on communication links between the map server 3 and vehicles.

In the present embodiment, the map server 3 acquires a planned route of the general vehicle Vb, identifies block areas related to the route, and notifies the general vehicle Vb of the information about the block areas. However, in other embodiments, the service vehicle Va may acquire a route of the general vehicle Vb, identify block areas related to the route, and provide the map data of the block areas to the general vehicle Vb.

Moreover, a service vehicle Va also acquires and retains map data of block areas associate with a route of the service vehicle Va itself from the map server 3. When acquiring the map data from the map server 3, the service vehicle Va may acquire and retain map data of extra areas, for example, block areas that are not directly related to the route of the service vehicle Va itself, such as block areas adjacent to those related to the route of the service vehicle Va, from the map server 3. This configuration can increase the opportunity for the service vehicle Va to provide map data general vehicles Vb.

### Second Embodiment

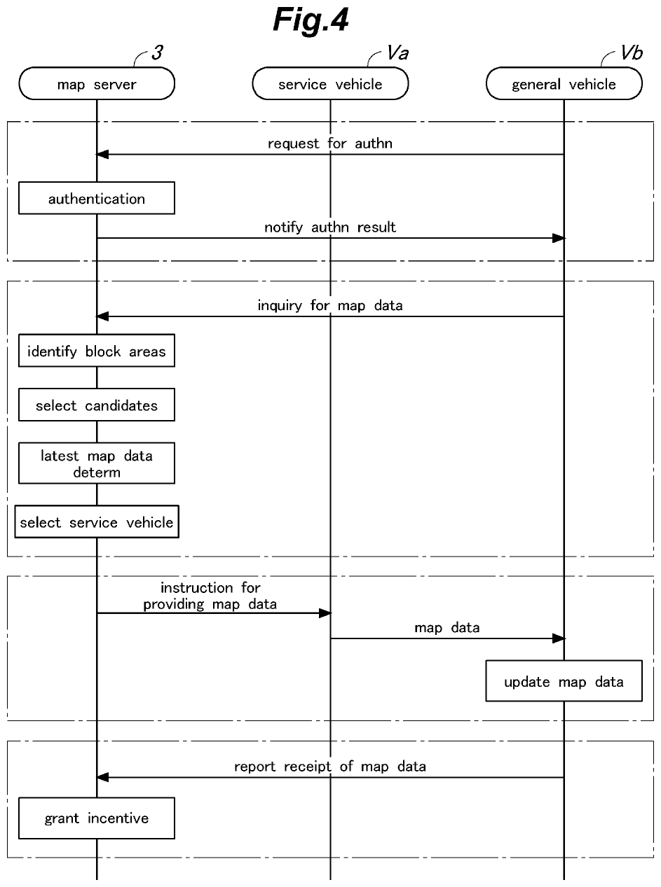

Next, a second embodiment of the present invention will be described. Except for what will be discussed here, this embodiment is the same as the above-described embodiment. FIG. 4 is a sequence diagram showing an operation procedure of a map update system according to the second embodiment.

In the first embodiment, the system performs the newer map data determination to determine whether or not the map data retained by the service vehicle Va is newer than that used in the general vehicle Vb (i.e., determine whether the retained map data meets the predetermined provision condition), and when the map data retained by the service vehicle Va is determined to be newer than the general vehicle Vb, the service vehicle Va provides the retained map data to the general vehicle Vb.

In the present embodiment, the system performs a latest map data determination; i.e., determines whether or not the map data retained by the service vehicle Va is the latest map data (i.e., determine whether the retained map data meets the predetermined provision condition), and when the map data retained by the service vehicle Va is determined to be the latest data, the service vehicle Va provides the retained map data to the general vehicle Vb. The point that the map server 3 manages block data, i.e., data of each block of the map data retained by the service vehicle Va, and information as to date and time of the last update of the map data retained by the service vehicle Va in the same manner as the first embodiment.

In the present embodiment, the map server 3 plays central roles in selecting a service vehicle Va which meets the predetermined provision condition, and instructs the selected service vehicle Va to provide map data to a requesting general vehicle Vb, which has made a request.

Specifically, first, a general vehicle Vb accesses the map server 3 and transmits a request for authentication for use of map data. Upon receiving the request for authentication from the general vehicle Vb, the map server 3 verifies the requesting general vehicle Vb and transmits a notification of authentication result to the general vehicle Vb. Upon successful authentication, the general vehicle Vb is authorized to receive and use map data provided from the map server.

Next, at the start of travel control for autonomous driving or driving assist, the general vehicle Vb transmits a data inquiry for map data related to a route of the vehicle to the map server 3. The data inquiry for map data includes information about the current position and the route of own vehicle, a vehicle ID of the general vehicle Vb (for example, a terminal ID of its communication device 9), and other information.

Next, when receiving the data inquiry for map data from the general vehicle Vb, the map server 3 identifies block areas in the map necessary for the requesting general vehicle Vb based on the information in the data inquiry; that is, information including the current position and the planned route of the general vehicle Vb.

Next, the map server 3 selects service vehicles Va as candidate vehicles that can provide map data to the requesting general vehicle Vb (candidate selection) based on the position data of the requesting general vehicle Vb and those of service vehicles Va. In the candidate selection, the map server 3 selects service vehicles Va located in the communication area for vehicle-to-vehicle communications of the requesting general vehicle Vb as candidate vehicles.

Next, the map server 3 determines whether or not the service vehicles Va selected as candidates retain the latest map data of the block areas necessary for the requesting general vehicle Vb (latest map data determination). Then, when there is a service vehicle Va retaining the required map data, the map server 3 selects the service vehicle Va.

Next, the map server 3 transmits to the selected service vehicle Va an instruction for providing the map data to the requesting general vehicle Vb. The instruction for providing the map data includes the vehicle ID of the requesting general vehicle Vb and information on block areas for which block map data are to be provided.

Then, when receiving the instruction for providing the map data from the map server 3, based on the information included in the instruction, the selected service vehicle Va transmits the map data to the requesting general vehicle Vb through vehicle-to-vehicle communications. In this step, the service vehicle Va transmits a set of block map data required for the requesting general vehicle Vb. The service vehicle Va can identify the requesting general vehicle Vb based on the Vehicle ID.

Next, when receiving the latest map data from the service vehicle Va, the requesting general vehicle Vb updates the map data retained therein with the latest map data.

Next, the requesting general vehicle Vb transmits to the map server 3 a report that the general vehicle Vb has received the map data from the service vehicle Va. Upon receiving that report from the requesting general vehicle Vb, the map server 3 performs an operation for granting an incentive reward to the provider of the service vehicle Va.

In the present embodiment, the system searches for service vehicles Va that retain the latest block map data of the block areas required for the requesting general vehicle Vb. However, in some cases, there is no service vehicle which retains the necessary latest block map data within a communication area for vehicle-to-vehicle communications of the requesting general vehicle Vb. In such cases, the requesting general vehicle Vb may give up acquiring map data from a service vehicle Va and receive the map data from the map server 3, instead. Or when there is a service vehicle Va that retains newer map data that that used in the requesting general vehicle Vb, the requesting general vehicle Vb may give up acquiring the latest map data, and instead acquire the newer map data from that service vehicle Va as in the first embodiment.

(First Variation of Second Embodiment)

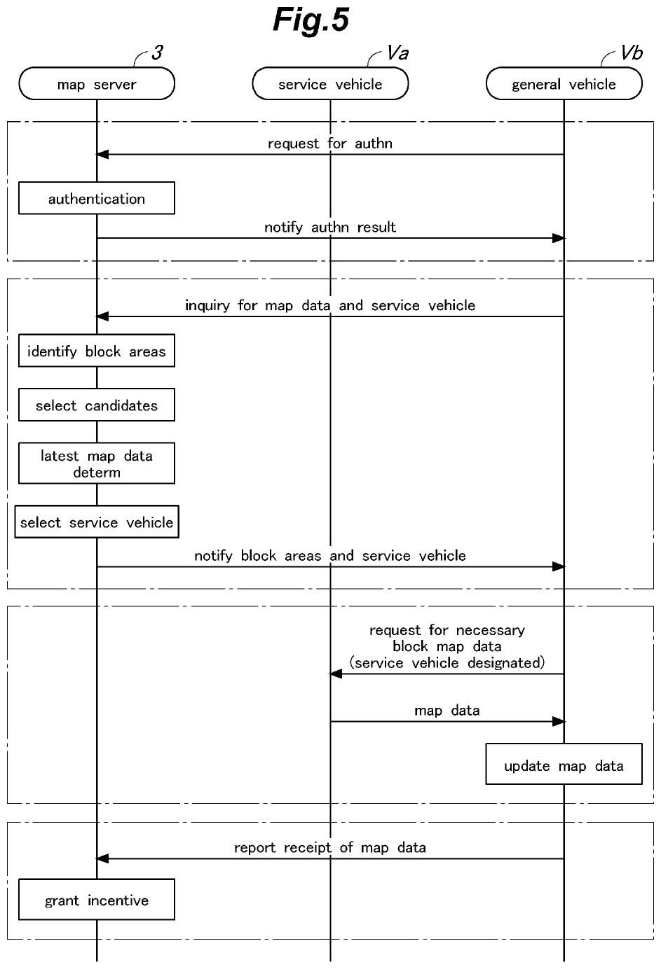

Next, a first variation of the second embodiment will be described. Except for what will be discussed here, this embodiment is the same as the above-described embodiments. FIG. 5 is a sequence diagram showing an operation procedure of a map update system according to the first variation of the second embodiment.

In the second embodiment, the map server 3 searches for the optimum service vehicle Va capable of providing the latest block map data required for the requesting general vehicle Vb, and instructs the service vehicle Va to provide the block map data to the requesting general vehicle Vb.

In this first variation of the second embodiment, the map server 3 notifies the requesting general vehicle Vb of the information on the optimum service vehicle Va capable of providing the latest block map data required for the requesting general vehicle Vb, and then the requesting general vehicle Vb requests the notified service vehicle Va to provide the block map data.

The specific operations of this embodiment are as shown in FIG. 5. The operations are the same as those of the second embodiment (see FIG. 4) until the map server 3 selects the service vehicle Va. When the map server 3 selects the service vehicle Va that retains the latest block map data required for the requesting general vehicle Vb, then the map server 3 transmits to the requesting general vehicle Vb a notification indicating the necessary block areas and the service vehicle Va capable of providing the map data.

Next, when receiving the notification indicating the necessary block areas and the service vehicle Va, the requesting general vehicle Vb transmits a request for map data of the necessary block areas to the designated service vehicle Va through vehicle-to-vehicle communications.

Then, when receiving the request for map data from the general vehicle Vb, the service vehicle Va transmits the block map data required for the requesting general vehicle Vb through vehicle-to-vehicle communications.

The subsequent operations are the same as those in the second embodiment (See FIG. 4).

(Second Variation of Second Embodiment)

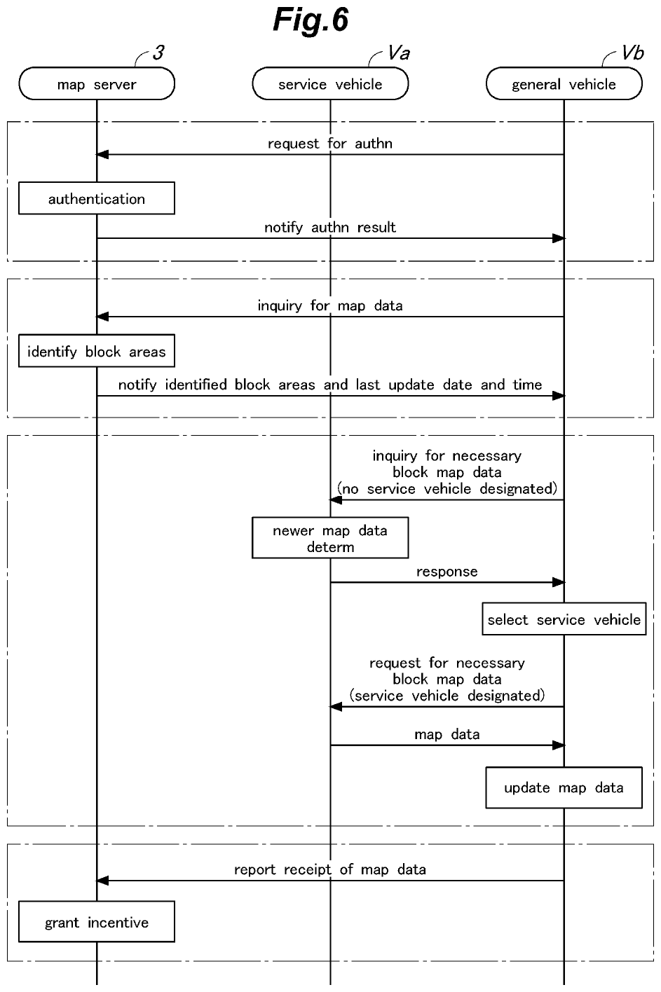

Next, a second variation of the second embodiment will be described. Except for what will be discussed here, this embodiment is the same as the above-described embodiments. FIG. 6 is a sequence diagram showing an operation procedure of a map update system according to the second variation of the second embodiment.

In this second variation of the second embodiment, the requesting general vehicle Vb searches for service vehicles that retain the latest block map data required for the requesting general vehicle Vb.

The specific operations of this embodiment are as shown in FIG. 6. The operations are the same as those of the second embodiment (see FIG. 4) until the map server 3 identifies a block area(s) for which the map data is required for the requesting general vehicle Vb. When identifying a block area(s) for which the map data is required for the requesting general vehicle Vb, the map server 3 acquires information as to date and time of the last update of the map data of the block area, and transmits a notification indicating the block area and the date and time of the last update of the map data of the block area to the requesting general vehicle Vb.

Next, when receiving the notification indicating the block area and the date and time of the last update of the map data of the block area, the requesting general vehicle Vb transmits a data inquiry for map data of the necessary block area to vehicles located nearby through vehicle-to-vehicle communications. The data inquiry for map data includes information about the date and time of the last update of the block map data.

Then, when receiving the data inquiry for map data from the general vehicle Vb, based on the information included in the data inquiry, a service vehicle Va determines whether or not the service vehicle Va retains the latest map data of the block areas necessary for the requesting general vehicle Vb (latest map data determination). Then, the service vehicle Va transmits a response to the request, the response including the determination result, to the requesting general vehicle Vb.

The subsequent operations are the same as those in the first embodiment (See FIG. 3).

### Third Embodiment

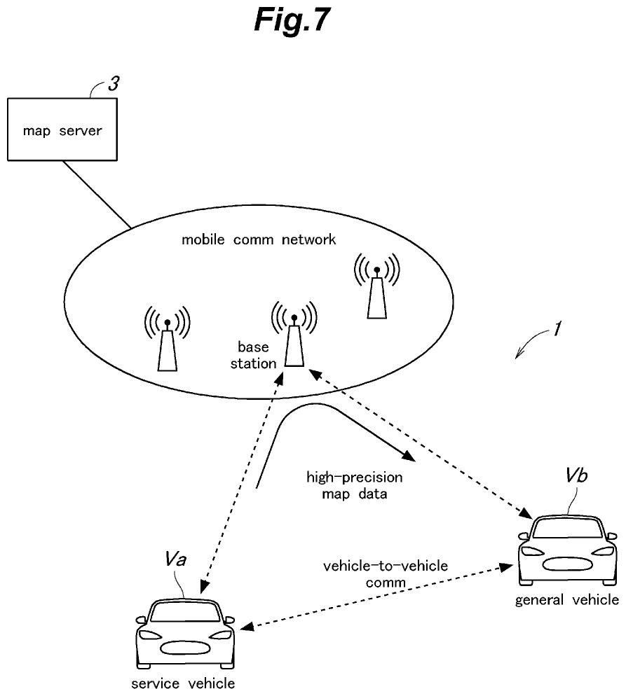

Next, a third embodiment of the present invention will be described. Except for what will be discussed here, this embodiment is the same as the above-described embodiments. FIG. 7 is a schematic diagram showing an outline of the map update system according to the third embodiment.

In the above-described embodiments, a service vehicle Va provides map data to a general vehicle Vb through vehicle-to-vehicle communications (V2X communications). In the third embodiment, a service vehicle Va provides map data to a general vehicle Vb through a mobile communication network. The mobile communication network includes a plurality of base stations, and a service vehicle Va can transmit map data to a general vehicle Vb via a base station(s).

In the present embodiment, a service vehicle Va may provide the latest map data to a general vehicle Vb as in the second embodiment. However, the map data to be transmitted is not limited to the latest map data in the present embodiment. When a service vehicle Va retains newer map data than that used in a general vehicle Vb, the service vehicle Va may transmit the newer map data to the service vehicle Va as in the first embodiment.

A service vehicle Va also exchanges control data (request and notifications) with a general vehicle Vb. Since the data volume of such control data is small, vehicle-to-vehicle communications are used to transmit the control data between a service vehicle Va and a general vehicle Vb. However, the data volume of map data is generally large, a high-speed and large-capacity mobile communication network may be used to transmit map data from a service vehicle Va to the general vehicle Vb.

When map data is provided from a service vehicle Va to a general vehicle Vb through vehicle-to-vehicle communications as in the first embodiment, a general vehicle Vb can receive map data only from service vehicles Va located within its communication distance for vehicle-to-vehicle communications. In the present embodiment, handovers between base stations, which form a mobile communication network, remove the limitation on communication distance, which means that only one of the service vehicle Va and the general vehicle Vb is required to be located within the communication area of a base station. As a result, a general vehicle Vb can receive map data from a service vehicle Va in a more reliable and stable manner.

In some cases, map data may be transmitted from a service vehicle Va to a general vehicle Vb via a base station where a handover does not occur, such as an access point for wireless LAN communications.

### Glossary

1 map update system
2 vehicle system
3 map server (server device)
16 control device
Va service vehicle
Vb general vehicle

1. A map update system for updating map data used in a vehicle for travel control, with map data provided from a server device, the system comprising:
a service vehicle configured to receive and retain the map data provided from the server device so that the service vehicle can provide the retained map data to a general vehicle located nearby,
wherein the service vehicle provides the retained map data to the general vehicle when the map data retained by the service vehicle meets a predetermined provision condition, the provision condition being a condition for allowing the map data retained by the service vehicle to be provided to the general vehicle.

2. The map update system according to claim 1, wherein the service vehicle provides the retained map data to the general vehicle through vehicle-to-vehicle communications.

3. The map update system according to claim 1, wherein, when the map data retained by the service vehicle is newer than map data used in the general vehicle, the retained map data meets the predetermined provision condition, and the service vehicle is allowed to provide the retained map data to the general vehicle.

4. The map update system according to claim 1, wherein, when the map data retained by the service vehicle is the latest map data, the retained map data meets the predetermined provision condition, and the service vehicle is allowed to provide the retained map data to the general vehicle.

5. The map update system according to claim 4, wherein the server device manages information as to date and time of the last update of the map data retained by the service vehicle, and determines whether or not the retained map data meets the predetermined provision condition.

6. The map update system according to claim 4, wherein one of the service vehicle and the general vehicle acquires information as to date and time of the last update of the map data retained by the other, and determines whether or not the map data retained by the other meets the predetermined provision condition.

7. The map update system according to claim 1, wherein the server device performs an operation for granting an incentive reward to a provider of the service vehicle.
